(19) United States
(12) Patent Application Publication
(10) Pub. No.: US 2013/0045849 A1
(43) Pub. Date: Feb. 21, 2013

(54) DEVICE AND METHOD FOR PROCESSING SHEETS OF PAPER OR OF ANOTHER FLEXIBLE MATERIAL

(71) Applicant: Rudolf Infanger, Hinwil (CH)

(72) Inventor: Rudolf Infanger, Hinwil (CH)

(73) Assignee: Ferag AG, Hinwil (CH)

(21) Appl. No.: 13/569,660

(22) Filed: Aug. 8, 2012

(30) Foreign Application Priority Data
Aug. 15, 2011 (CH) 01339/11

(51) Int. Cl. B31F 7/00

(52) U.S. Cl. 493/357

(57) ABSTRACT

A method and a device for processing sheets of paper or another flexible, flat material. The device includes a feed device for conveying the sheets in a conveying direction (F) at a distance to one another or in an imbricate formation, and a folding assembly which is arranged downstream of the feed device. The folding assembly is a buckle folding assembly for creating at least one fold which runs transversely to the conveying direction (F). A scoring device is present which is capable of scoring the sheets at the location of the envisaged fold transversely to the conveying direction (F), before the folding and during the conveying, for improving the quality of the fold. The sheets can be folded with a good quality even at high processing rates by way of this, and can be subsequently processed further.

### BACKGROUND OF THE INVENTION

The invention lies in the field of the further processing of printed products and relates to a device and to a method for processing sheets of paper or of another flexible material. The processing in particular includes the folding of the sheet.

A sheet is hereinafter indicated as a flat, flexible object which essentially extends in two spatial directions, whilst the extension in the third direction relative to these is small. The sheet as a rule has a rectangular basic shape, wherein other shapes are also conceivable. Several flat objects can lie over one another. The object can already be folded once or several times. For the sake of simplicity, all objects which are further processed according to the invention, in particular folded, are indicated as sheets.

Different types of folding machines are known for the folding of individual sheets or of a continuous web material:

With the buckle fold, a sheet is pulled in through a feed roller pair and is inserted into a folding plate or buckling plate. It runs up to the abutment of the plate and abuts there. Since it is simultaneously transported further, a crease is formed in the buckling space and this crease is gripped by two rotating folding rollers and is broken. The folded sheet is transported out of the folding unit by way of this. The fold is created perpendicularly to the movement direction of the sheet. One of the folding rollers can also serve as a feed roller.

With the chopper fold (knife fold), the sheet is conveyed by transport belts up to an abutment, so that it comes to lie above two folding rollers. It is hit between the two folding rollers by way of a folding knife, and these folding rollers then produce the fold and eject the sheet downwards.

With the former fold, sheets or a continuous web are folded over a former, led between two folding rollers rotating in opposite directions, and folded there.

With the folding jaw principle, a paper web runs onto a collecting cylinder and is transversely cut with a cutting cylinder. In the fold position, the sheets are hit by the folding knife integrated into the collecting cylinder, between the folding jaws of the adjacent folding jaw cylinder which lie opposite one another, and are folded. The folded sheets subsequently reach the imbricate delivery via a delivery wheel.

With former fold devices, it is known to score the paper web or the individual sheets at the location of the envisaged fold before the folding. The scoring device comprises a wheel which acts continuously on the web or the sheets and creates a score in the conveying direction of the sheet or the web. This for example is described in WO 2011/014968.

A folding jaw device is known from DE-B 10 2008 002 229, with which an endless paper web is scored transversely to the conveying direction with a scoring device. The scoring device comprises two rollers driven in opposite directions, of which one carries the scoring knife and the other a counter-element. The scoring knife and the counter element are orientated in the direction of the axis of the rollers.

With buckle fold devices, it is known for example from U.S. Pat. No. 3,729,186 or EP-A 2 149 530 to pre-treat or post-treat the sheets before and after the transverse folding respectively, by way of creating a perforation or score running in the conveying direction and, thus, perpendicularly to the envisaged fold line. The scoring does not therefore influence the quality of the fold, but serves for the simplified further processing, e.g. for the subsequent cross-folding.

EP-B 1 331 105 discloses a method and a device for creating stitched brochures. Individual sheets or stacks of such sheets are scored along the envisaged fold line or stitch line, during the conveying. A roller pair is present for scoring. The axes of the rollers are orientated perpendicular to the conveying direction. One of the rollers along its periphery has a projection, the other a recess. The rollers roll on one another and can receive the sheets between them. The score therefore runs in the conveying direction and perpendicularly to the leading edge of the sheet. The scored sheet which is also deformed in a V-shaped manner by way of this runs through the stitching station on a saddle. The conveying direction is subsequently changed by 90°, so that the initial leading edge is now orientated parallel, and the scored line perpendicular to the changed conveying direction. The sheet is then folded along the pre-scored line. This device is only suitable for low processing rates due to the necessary direction change. In particular, it is not suitable for the production of newspapers, magazines and other printed products with processing rates in the region of tens of thousands of pieces per hour.

US 2010/0304945 discloses a buckle folding machine, with which a score is created at the envisaged fold position, i.e. transversely to the conveying direction, by way of a scoring device. For this, after introduction into the folding device, the sheet is scored with a scoring wheel which is moved transversely over the sheet. This is not possible during the conveying of the sheet, but the sheet must be stopped such that the scoring wheel is located at the position of the envisaged fold and can execute the transverse movement there. Such devices are therefore suitable only for very small processing rates. In particular, they are not suitable for the production of newspapers, magazines and other printed products with processing rates in the region of tens of thousands of pieces per hour.

### BRIEF SUMMARY OF THE INVENTION

It is therefore the object of the invention, to further develop a processing device for sheets with a buckle folding device, in a manner such that an optimal fold quality is achieved even with high processing rates in the region of tens of thousands of examples per hour.

The device according to the invention serves for processing sheets of paper or of another flexible material, in particular of individual sheets or sheets collated as stacks. It comprises a feed device for conveying the sheets in a conveying direction at a distance to one another. A folding assembly is present, which is arranged downstream of the feed device. The folding assembly is a buckle folding assembly for creating at least one fold which is orientated transversely to the conveying. Moreover, a scoring device is present, which is capable of scoring the sheets at the location of the envisaged fold transversely to the conveying direction, before the folding or during the conveying. By way of the invention, one succeeds in the creation of a transverse fold with a quality which is improved by the prior scoring, even with buckle folding machines. Thereby, the scoring is effected during the conveying, thus without stopping the sheet or without interrupting the movement along the conveying path. The high processing rates can thus be maintained.

The method according to the invention comprises the following steps: conveying the sheets at a distance to one another or in an imbricate formation in a conveying direction along a conveying path, feeding the sheets to a folding assembly which is a buckle folding assembly and creating at least one fold which runs transversely to the conveying direction. According to the invention, before the folding, the sheet is scored at the location of the envisaged fold transversely to the conveying direction with a scoring device, whilst the sheet is conveyed further along the conveying path.

The method and the device in particular are suitable for folding high-quality printed products, i.e. printed products on more stable paper and/or those with high-gloss printing. Often creases in the region of the fold occur with such products without previous scoring, or print ink bursts on folding. The paper is mechanically pre-treated by way of the scoring, by way of the fibres in the sheet being broken, so that the subsequent folding can be effected without a reduction in the quality of the sheet. The scoring is a controlled breaking of fibres in the sheet, so that the ink deposition is not disintegrated with the subsequent folding of the printed sheet.

The sheets are fed to the folding assembly by the feed device. The sheets, for example, come directly from a printing machine or from an intermediate storage, i.e. from a stack or a reel. The feed device is preferably a belt conveyor, on which the sheets are conveyed in a lying manner. The conveying path, as a rule, runs in one plane, e.g. in the plane of the conveyor belt of the belt conveyor, but can also have curved sections, i.e. in the entry region of the folding assembly.

The orientation of the edges of the sheet relative to the convening direction remains the same during the processing. A sheet edge which was leading at the beginning of the method, thus always remains perpendicular to the current conveying direction. Likewise, the scored line always runs perpendicularly to the current conveying direction. The exception to this is any further processing after the folding. Hereby, other orientations can be selected, e.g. after transfer of the sheet into grippers or other intermediate conveyors and further processing devices.

The scoring device is operated in a cycled (paced) manner and intermittently acts on the sheets. Its function is synchronised with the advance (position and conveying speed) of the sheets, so that the score is produced at the location of the envisaged fold.

The scoring device can be integrated into the folding assembly. Alternatively, it is arranged in front of the folding assembly. Preferably, when acting on the sheets, the scoring tool has a movement component in the conveying direction, in particular with the same path speed as the sheet, so that the sheet does not need to be stopped or is not damaged on scoring.

In one embodiment, the buckle folding assembly has at least three rollers as well as a folding plate with a preferably adjustable abutment. In each case, at least two of the rollers cooperate with one another as folding rollers or feed rollers.

In one variant of the invention which is based thereon, the scoring device or its scoring tool is integrated into at least one of the rollers of a buckle folding assembly. Preferably, it is integrated into at least one of the rollers, which acts as a feed roller. This has the advantage that components which are present in any case, such as the feed roller, can be used as a carrier for the scoring tool. The device can therefore be designed mechanically in a relatively simple manner. A further advantage lies in the fact that the folding takes place directly after the scoring, without the sheet having to cover a longer path distance therebetween. The risk of the sheet displacing within the folding assembly and therefore of the position of the score and of the fold not corresponding the desired position is reduced.

The scoring device comprises an elongate scoring knife which is arranged essentially parallel to the axis of the assigned roller in the region of the lateral surface of the roller. Preferably, a counter-tool is also provided, e.g. an elastic region in a further roller which cooperates with the scoring roller.

The scoring roller and the roller with the counter-tool are preferably mounted in a housing of the folding assembly such that their positions can be exchanged. In this manner, one can make a setting as to whether the score is produced on the upper side or on the lower side of the sheet.

Alternatively, the scoring device can be arranged upstream. It then for example comprises two rollers driven in opposite directions, of which one carries the elongate scoring knife and the other acts as a counter-element. Alternatively, the scoring device can also comprise a translatorily moved component, e.g. a scoring knife which is moved perpendicularly to the conveying plane and thus acts periodically on the sheets.

With all variants, the scoring knife is elongate and is aligned perpendicularly to the momentary conveying direction of the sheets. With rectangular sheets, it is aligned parallel to the leading edge or perpendicular to the side edges. The scoring knife at one point in time acts on the whole width of the sheet, so that the conveying does not need to be interrupted. Scoring knives mounted on a rotating body always also have a movement component parallel to the conveying direction, which under certain circumstances has advantages at high conveying speeds.

The profiles of the scoring knife and of the counter-tool can be selected according to the requirements, e.g. V-shaped or W-shaped.

In the case that the scoring knife is integrated into one of the rollers of the buckle folding assembly, it is preferably moveably arranged relative to the lateral surface and depending on the rotational position of the roller projects out of the lateral surface or is sunk into or behind the lateral surface. Thus, one succeeds in the knife projecting out of the lateral surface where possible only at the location of the processing, and in the roller otherwise having a surface without projections. In this manner, one avoids the knife acting on parts of the sheet deflected around the roller, at locations other than at the location of the processing. Moreover, imbalances, knocks and frequency-dependent resonances which could occur at high revolving speeds are reduced. The lateral surface preferably has a recess for sinking or immersing the scoring knife. The scoring knife is preferably eccentrically positioned in the roller, in particular in the lateral surface. It can be moved by a control cam which preferably has an axis running eccentrically to the axis of the roller. The travel of the knife can be influenced by way of setting the eccentricity of the axis of the control cam. With this, the depth of the score can be adapted to different demands, e.g. to different materials. The rollers contain preferably exactly one scoring knife. They can, however, also contain two or more scoring knives.

In one embodiment, the feed device comprises an aligning device with at least one movable abutment, on which the sheets are aligned during the conveying. The aligning device preferably sets a defined distance of the front edges of the sheets or a defined pace, in which the sheets are to be transferred to the folding assembly. This is particularly advantageous if a common drive for the aligning device, the scoring device and the folding assembly is envisaged or if these components are driven synchronously by way of different drives.

As a rule, several abutments are present which have a certain distance in the conveying direction. This distance sets the distance of the leading edges. The sheets are fed to the folding assembly individually or on an imbricate formation, depending on whether the length of the sheets in the conveying direction is greater or smaller to the distance of the abutments.

The cycle of the aligning device preferably corresponds to the cycle of the scoring device. Particularly preferably, the diameter of the roller which carries the scoring knife corresponds to the distance of consecutive abutments of the aligning device. In this manner, one succeeds in the scoring roller and the aligning device being able to be driven by the same drive, and in the score having a defined, constant distance to the front edge.

The aligning device is preferably displaceable in the conveying direction relative to the folding assembly. With a constant conveying speed and path speed of the scoring knife on the assigned roller, thus the distance of the score to the front edge can be adapted. This, for example, serves for adapting to different sheet formats.

The feed device additionally to the aligning device can comprise a support surface and a conveyor belt. Thereby, the active section of the conveyor belt is arranged in the support surface. The conveyor belt is moved with a greater speed that the at least one abutment of the aligning device, so that lying-on sheets are conveyed in the conveying direction against the abutment and are aligned there.

In one embodiment, the aligning device and the scoring device are driven synchronously to one another. Preferably, the folding assembly is driven synchronously to this. In one variant, a common drive is present for all components.

The abutment or abutments of the aligning device preferably define an abutment surface which acts on a sheet edge and whose orientation relative to the conveying direction may be set. The orientation of the sheets relative to the scoring knife can be exactly set by way of this. Preferably, for this, an abutment comprises at least two abutment elements cooperating with one another, which together define the abutment surface and whose position relative to one another can be set, in particular also during the operation.

The aligning device, preferably, also functions according to the conveyor belt principle and for example comprises at least two parallel belts which each carry abutment elements at equal distances, e.g. cams projecting upwards out of the support surface. The belts are preferably driven via different drive shafts, for adapting the relative position of the abutment elements which cooperate with one another in each case. The rotation positions of the drive shafts relative to one another can preferably be set, in order to set the position in each case of two cooperating abutment elements and thus the orientation of the abutment surface. The rotation position of a drive shaft or phase shift to the other drive shaft can also be changed during operation by way of acting on the assigned belt, in particular by way of changing the position of its deflections. This has advantages, since one does not need to stop the whole device in order to be able to carry out the fine adjustment.

Preferably, a transfer conveyor which is part of the feed device is provided for the precise transfer of the sheets to the folding assembly. The aligned sheets are transported with this transfer conveyor, between the aligning device and the folding apparatus, without changing their orientation relative to the conveying direction. The transfer conveyor in particular is a vacuum conveyor, on whose conveyor belt the sheets are fixed by way of a vacuum.

The aligning device which is described here and which is shown in the figures, with two belts and aligning elements which are arranged thereon and whose position relative to one another can be set by way of adapting the rotation positions of the drive shafts, can also be applied in other feed devices, in which an exact alignment of the conveyed objects is important. It is not limited to the folding devices or score-folding devices which are described here.

The device can be complemented by further components:

A conveying-away device can be arranged at the exit of the folding assembly, to which device the folded sheets are transferred. The conveying-away device, for example, is a belt conveyor, on whose conveyor belt the sheets are deposited individually or in an imbricate formation. The distance of the sheets can be set by way of adapting the conveying speed of the belt conveyor which does the conveying away.

Further processing devices can connect to the conveying-away device or directly to the exit of the folding assembly. These can serve for manufacturing an end product or intermediate product from the folded sheet and further flat objects, in particular printed products. The folded sheet and the further objects can be deposited onto one another (collating), be applied astride one another in the opened condition (collecting) and/or be inserted into one another (inserting).

Further processing steps, e.g. gluing, stitching, inserting into a common cover, cutting, introducing supplements such as goods samples or separately created printed products, film wrapping, can subsequently be effected.

The processing device with its basic components of the feed device and the folding assembly can thus serve as a feeder for collation devices, collection devices and insertion devices for printed products, said devices being known per se. Hereby, one processes in the stream with the high processing speeds of the subsequent devices. Thus in principle, no intermediate storage of the objects is necessary from the printing machine to the end product. The sheets can however also be processed from the stack or from the reel.

The device described in this application can also be applied as a feeder for a further processing device, in particular for a collation device, an insertion device or collection device, even without a scoring device or with the scoring device disconnected. Thus one can forego the scoring if the nature of the sheets permits an adequate folding quality even without the scoring.

### BRIEF DESCRIPTION OF THE DRAWINGS

Examples of the invention are represented in the drawings and are described hereinafter. In a purely schematic manner are shown in:

FIG. 1 a three-dimensional view of a processing device according to the invention, with a feed device and with a folding assembly, on processing individual sheets;

FIG. 2 a three-dimensional view of a processing device according to FIG. 1 on processing sheets in an imbricate formation;

FIG. 3 a processing device according to FIG. 1 or 2, in a view perpendicular to the conveying direction (lateral view);

FIG. 4 the feed device of the processing device according to FIG. 1 or 2, in a view obliquely from above;

FIG. 5 the feed device of the processing device according to FIG. 4, in a view obliquely from below;

FIG. 6 the folding assembly of the processing device according to FIG. 1 or 2, in a view obliquely from above;

FIG. 7a-d the folding assembly according to FIG. 6 and parts of the feed device and conveying-away device, in a lateral view at different points in time, on processing sheets;

FIG. 8a+b sections through the scoring device at two different points in time;

FIG. 9a+b sections through a roller of the scoring device, in the region of the scoring knife;

FIG. 10a+b the adjusting mechanism for adapting the travel, in different views;

FIG. 11 a variant of the device shown in FIG. 1, with a scoring device arranged upstream of the folding assembly, whose scoring knife is moved in a rotating manner;

FIG. 12 a variant of the device shown in FIG. 1, with a scoring device arranged upstream of the folding assembly, whose scoring knife is moved in a translatory manner; and

FIG. 13-15 a device according to the invention with different variants of the further processing of the folded sheets.

### DETAILED DESCRIPTION OF THE INVENTION

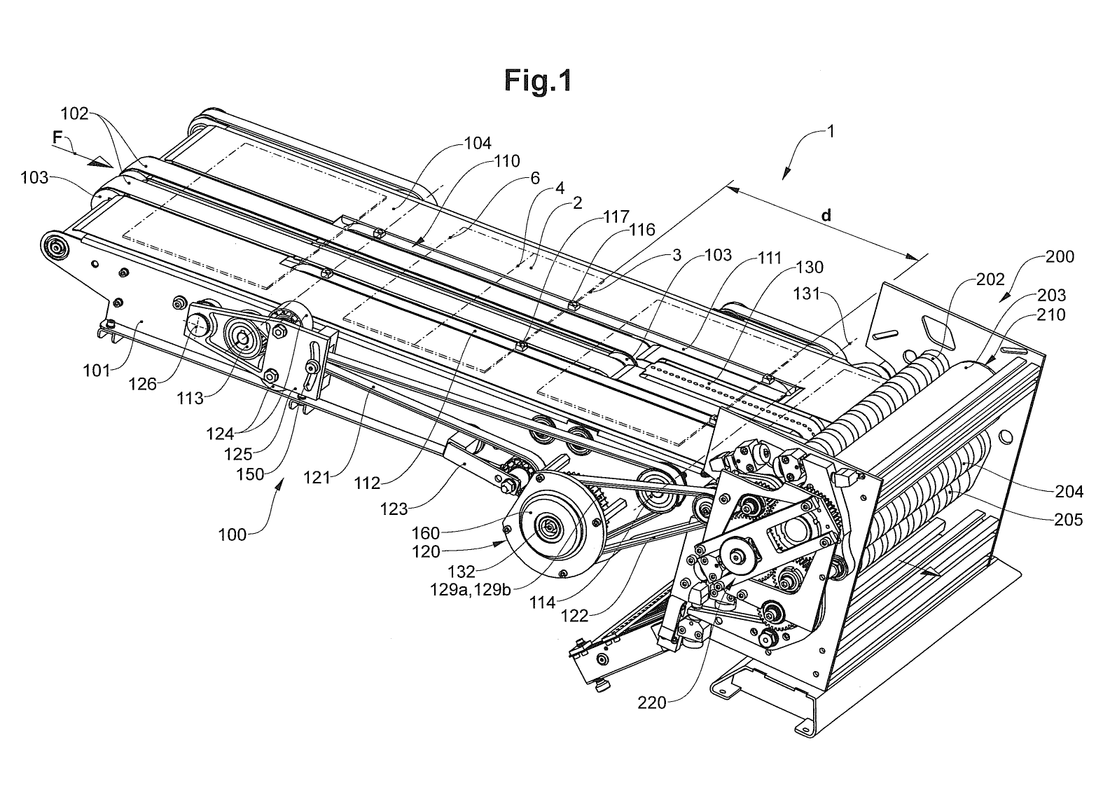

FIG. 1 shows a three-dimensional view of a processing device 1 according to the invention, with a feed device 100 and with a folding assembly 200, on processing sheets 2 which are conveyed individually at a distance to one another. The sheets 2, as initially mentioned, can also be stacks of flat objects and/or already folded objects.

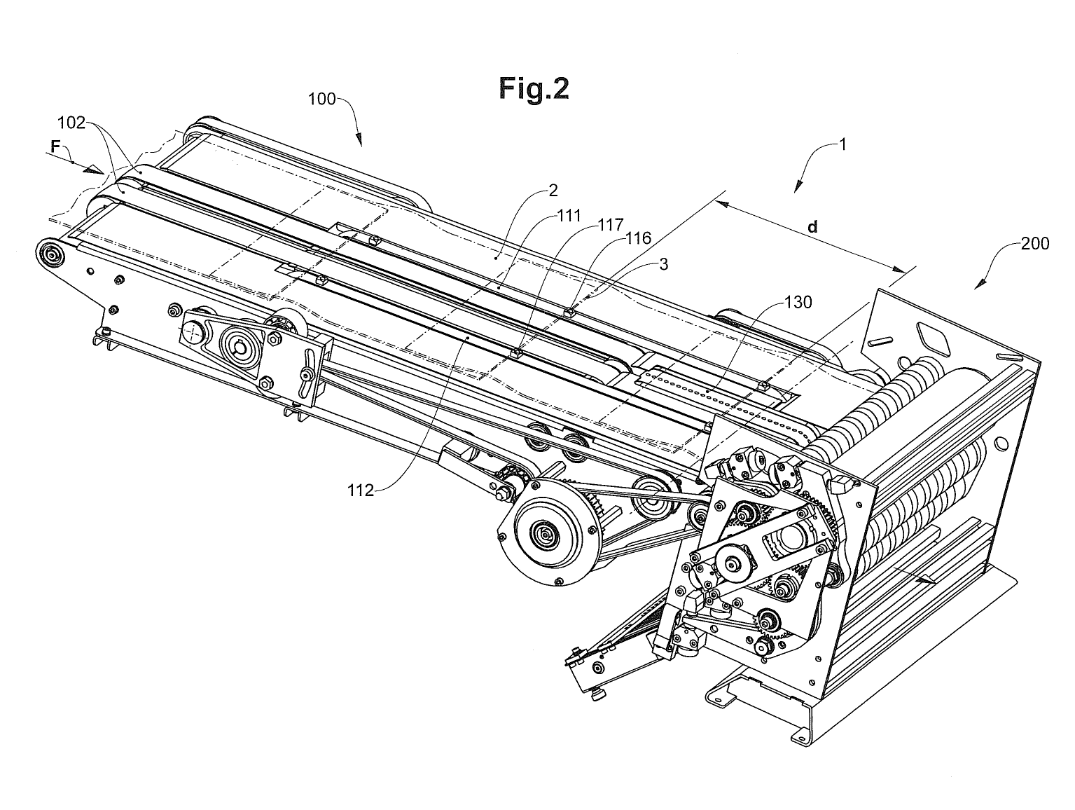

FIG. 2 shows the same device 1 on conveying sheets 2 in an imbricate formation with a partial overlap. The trailing edges 6 of a sheet 2 are located on the leading edges 3 of the trailing sheet.

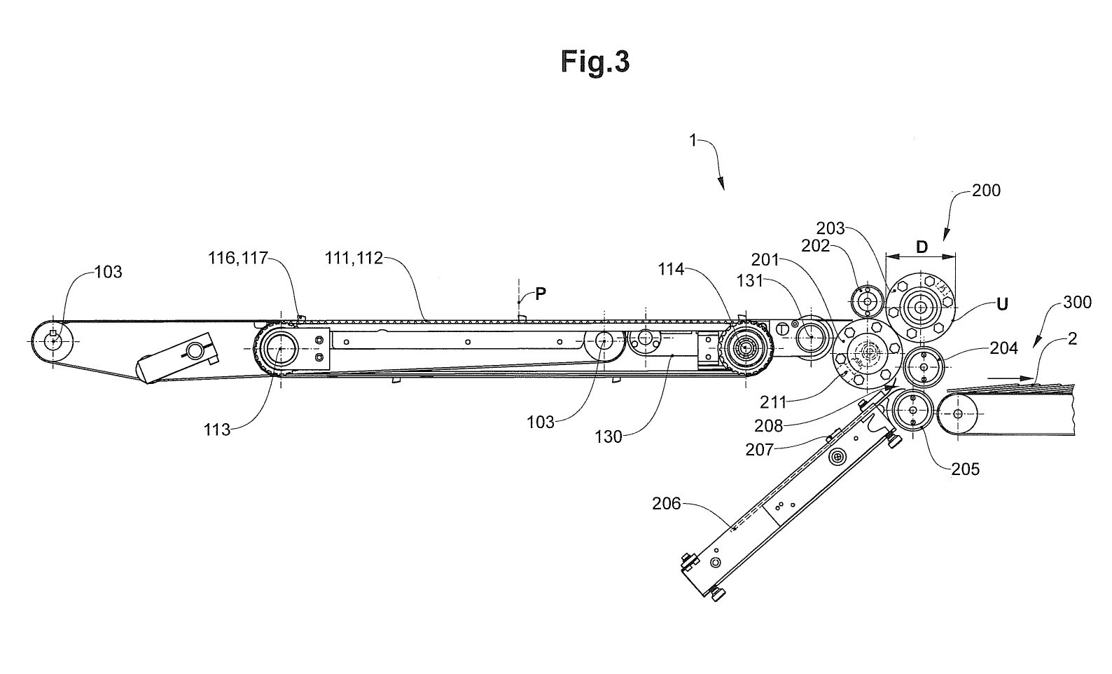

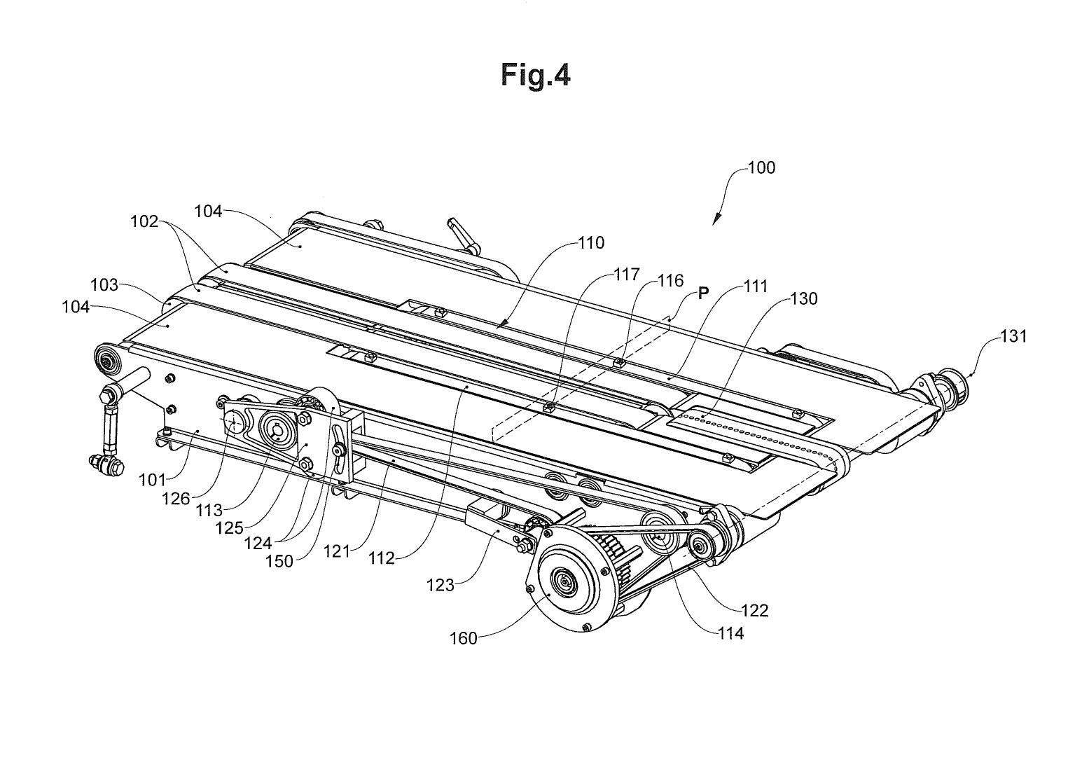

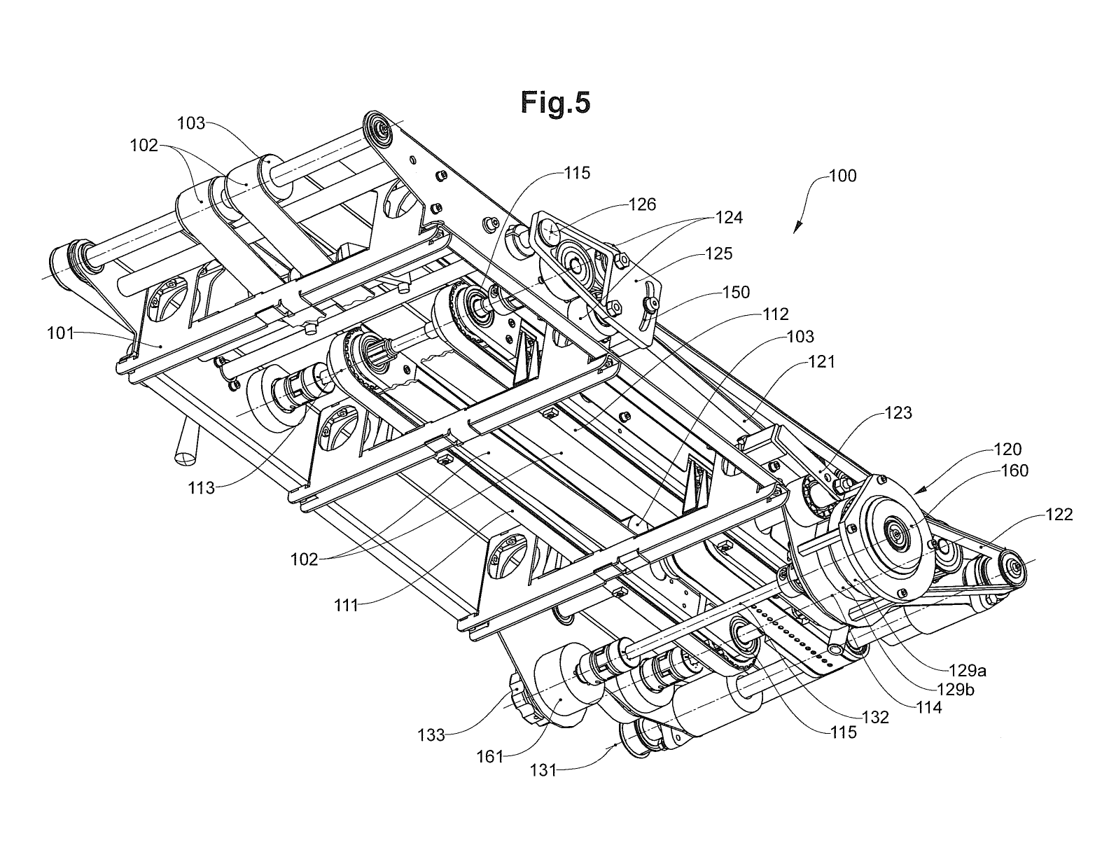

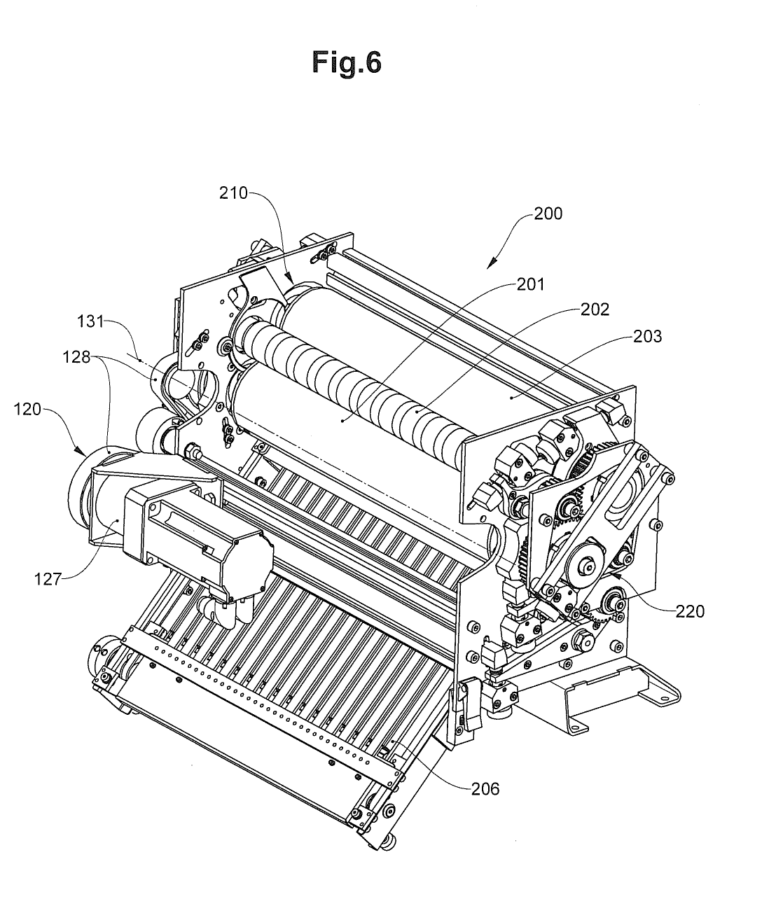

FIG. 3 shows the same device in a sectioned view from the side. FIGS. 4 and 5 show details with regard to the feed device 100, and FIG. 6 shows the folding assembly 200.

FIG. 1-6 are hereinafter described together.

The feed device 100 comprises a mount 101, in which the components are mounted and which forms a plane support surface 104 for the sheets. The active section of a belt conveyor is located in the support surface 104, wherein the belt conveyor here comprises two parallel conveyor belts 102 orientated in the conveying direction F. The conveyor belts 102 are deflected about two deflection rollers 103 and are driven by a drive which is not represented here. Seen in the conveying direction F, the folding assembly 200 is located at one end of the support surface 104. The sheets 2 are fed at the other end such that they come to lay on the active section of the conveyor belts 102. The envisaged or actual fold and score position is indicated with the reference numeral 4.

The feed device 100 moreover comprises an aligning device 110, which serves for aligning the sheets 2 transversely to the conveying device F as well as for creating a defined distance of the leading edges 3. The aligning device 110 has two toothed belts 111, 112 which can act through recesses in the support surface 104 on the sheets 2 and are guided around two deflections 113, 114 such that they run parallel to the conveyor belts 102 in the conveying surface. Projecting abutment elements 116, 117, e.g. cams are attached on the toothed belts 112, 112. In each case, a pair of abutment elements 116, 117 lying next to one another serves for aligning the front edges 3 of the sheets at a distance d for consecutive sheets.

The conveyor belts 102 end in front of the exit-side region of the feed device 100. A vacuum conveyor 130 which transfers the sheets to the folding assembly 200 is present in this region, for moving the sheets forward. The vacuum conveyor 130 fixes the sheets 2 in the position, in which they are aligned by the aligning device 110. It thus ensures a very accurate transfer to the folding assembly 200, without the sheets being able to displace during the transfer. The vacuum conveyor can consist of a vacuum belt or several vacuum belts which are arranged next to one another.

The aligning device 110, the vacuum conveyor 130 and the folding assembly 200 are synchronously operated by way of a common drive device 120, so that the sheets run through the installation at an essentially constant speed. The entry-side belt conveyor conveys the sheets 2 with a speed which is slightly increased compared to this (by about 20%), so that the sheets run against the abutment elements 116, 117 and can be aligned thereon.

The drive device 120 is hereinafter described in more detail. A motor 127 on the one hand by way of a suitable coupling via drive toothed belts 128 sets the rollers 201-205 of the folding assembly 200 in motion. On the other hand, the shaft 131 is driven, via which the conveyor belt of the vacuum conveyor 130 runs. This shaft 131 is coupled via a further drive toothed belt 122 to a toothed wheel 129a which in turn lies on a shaft 132. A hand wheel 133 is located at the end of this shaft 132 which lies opposite the toothed wheel 129a. A further drive toothed belt 121 runs over a toothed wheel 129b which is arranged coaxially to the toothed wheel 129a, as well as around two further deflection rollers which are coaxially coupled to the shafts 113 and 114. The toothed belt is tensioned with a belt-tensioner 123. The toothed belts 111, 112 of the aligning device 110 run around deflection rollers which are arranged on the shafts 113 and 114. The shaft 113 which is away from the folding assembly 200 thereby serves as a drive shaft for the rear toothed belt 111, whereas it is coupled to the front toothed belt 112 via a freewheel. The shaft 114 which faces the folding assembly 200 serves as a drive shaft for the front toothed belt 112, whereas it is coupled to the rear toothed belt 111 via a freewheel.

Both toothed belts 111, 112 are therefore driven by different drive shafts 113, 114. This has the purpose of being able to set the relative position of the abutment elements 116, 117 lying next to one another, in a certain range, by way of introducing a small phase shift between the toothed belts 111, 112. The position of the abutment surface P which is fixed by the two abutment elements 116, 117 can be varied by way of this. Thus the leading edges 3 can be aligned very accurately transversely to the conveying direction F, even in running operation. It is not necessary to stop the installation, by which means the effort for adjustment is significantly reduced compared to conventional installations.

This fine adjustment is achieved by way of the path of the drive toothed belt 121 being changed by way of adjustable deflection rollers 124 in the vicinity of one of the drive shafts 113 or the associated deflection. The deflection rollers 124 are mounted in a carrier 125 which can be pivoted relative to the mount 101 about an axis 126. A fixation element 150 (elongate hole with fixation screw) serves for setting the pivot position. The length of the upper section of the drive toothed belt 121 is shortened or extended by a few millimetres depending on the position of the carrier 125. Accordingly, the position of the lower section is lengthened or shortened. For this reason, the relative rotation position of the drive shafts 113, 114 and thus the phase shift between the toothed belts 111, 112 or the assigned abutment elements 116, 117 changes.

A phase shift between the toothed wheels 129a, 129b can be set by way of the hand wheel 133 which is coupled to the shaft 132 via a load moment block 161. A phase shift between the drive components of the aligning device 110 and those of the folding assembly 200 are set with this and a phase shift between the abutment elements 116, 117 and the scoring knife 211 is changed by way of this. In other words, one sets the time which passes between the release of the front edges at the exit of the feed device and the action of the scoring knife 211. This setting possibility serves for adapting the device to different sheet formats or to different distances of the scoring to the front edge.

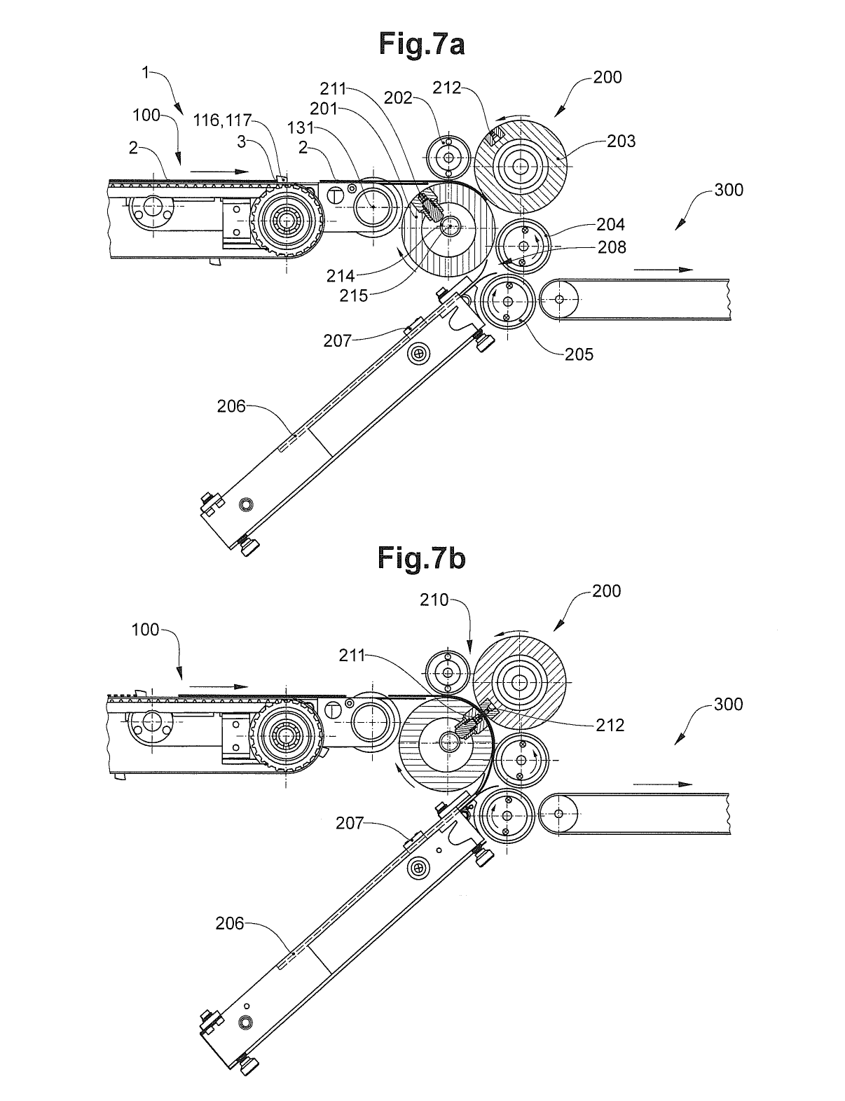

The folding assembly 200 is represented in FIG. 6. FIGS. 7a-d show the course on folding. The folding assembly 200 is shown in a section parallel to the conveying direction and perpendicular to the fold line in FIGS. 7a-d.

The folding assembly 200 here comprises five rollers 201, 202, 203, 204, 205 whose longitudinal axes are arranged in each case in parallel and run perpendicular to the conveying direction F. The rollers 201, 202, 203, 204, 205 are driven by the same drive device 120 as the feed device 100 or the aligning device 110 which is there. The drive belt 128 serves for transmitting the drive force. The belt 128 is coupled to the rollers 201, 202, 203, 204, 205 as well as to the drive shaft 131 of the aligning device 110. The drive shaft 131 which is only indicated here in a dot-dashed manner is arranged in recesses in the side regions of the housing of the folding assembly 200 in operation.

On the entry side, a sheet is pulled in by two feed rollers 201, 202 and via further deflection rollers 203, 204 is introduced into the folding plate 206 with the leading edge 3 in front (FIG. 7a+b). The folding plate 206 has an adjustable abutment 207 which determines its depth and thus the distance of the fold line to the front edge. If the front edge abuts against the abutment 207, the sheet 2 arches in the buckling space 208 between the rollers (FIG. 7c). The arching at a defined location is supported by the previous scoring. On further conveying the trailing region of the sheet, the arched, scored region is gripped by the two folding rollers 204, 205 arranged at the exit side and the fold is broken. The folded sheet 2 is conveyed out of the folding assembly 200 by the folding rollers 204, 205 and comes to lie on a conveyor belt of a conveying-away device 300.

In the embodiment of the invention shown here, the scoring device 210 is integrated into the folding assembly 200. At least one of the rollers of the buckle folding assembly has a double function, specifically for folding and/or conveying within the buckle folding assembly as well as for scoring the running-through sheet. In the specific example, the feed roller 201 which is located below the conveying plane serves also as a carrier of the scoring knife 211. The scoring knife 211 runs parallel to the axis of the roller 201 or perpendicular to the conveying direction. It therefore scores the running-through sheet 2 transversely to the conveying direction or parallel to its leading edge 3 at the position 4. The scoring-feed roller 201 cooperates with the further roller 203 provided for deflection. This carriers a counter-tool 212 for the scoring knife 211, e.g. an elastic region which is likewise located parallel to the axis of the roller 203 in the lateral surface of the roller. The rollers 201 and 203 are moved in opposite directions and contact one another along a line. Their positions can be exchanged if the position of the score (at the top or bottom on the sheet) is to be changed.

The circumference U of the scoring roller 201 and of the counter-roller 203 is selected such that it corresponds to the distance d of the front edges 3 of the sheets 2 to be scored. It thus corresponds also to the distance of the abutment elements 116, 117 seen in the conveying direction. Therefore it is the case of d=U=πD, wherein D is the diameter of the roller. With a common drive therefore, a constant phase shift prevails between the abutment elements and the scoring knife, so that the score is always produced at a constant distance to the leading edge 3.

Since the scoring-feed roller 201 also contacts the other feed roller 202 as well as one of the folding rollers 204 along a line, an unbalanced running and undesired further scoring can occur with a projecting scoring knife 211. For this reason, it is advantageous if the scoring knife 211 can be sunk into or behind the lateral surface of the roller 201.

In the represented case, the travel of the scoring knife 211 depends on the rotation position of the roller 201 and is preferably maximal in the scoring position, i.e. where the scoring knife is located at the contact line of the scoring-feed roller 201 and the counter-tool roller 203 (FIG. 7b). Preferably, the travel mechanism is set such that the scoring knife 211 is retracted completely into or behind the lateral surface 216, already approx. 45° before and after the scoring position (FIG. 7a, c, d). Thus, no undesired scoring in the sheet can arise along the contact lines to the rollers 202, 204.

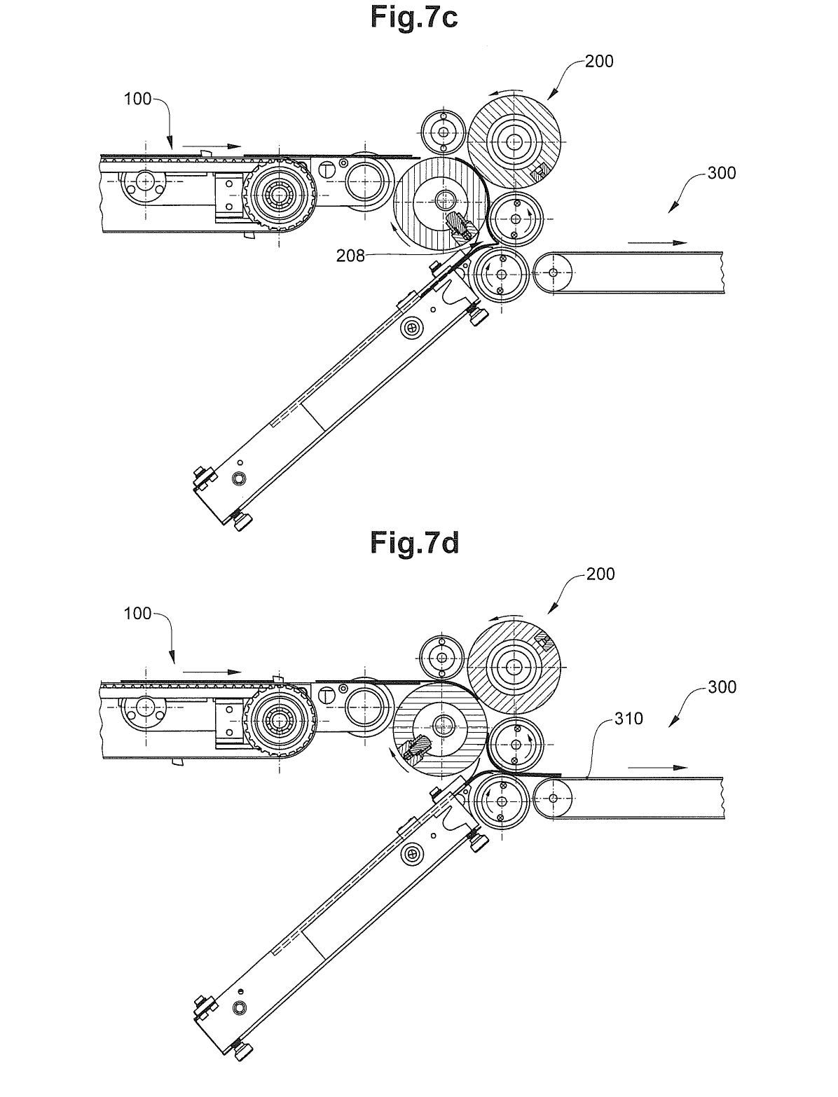

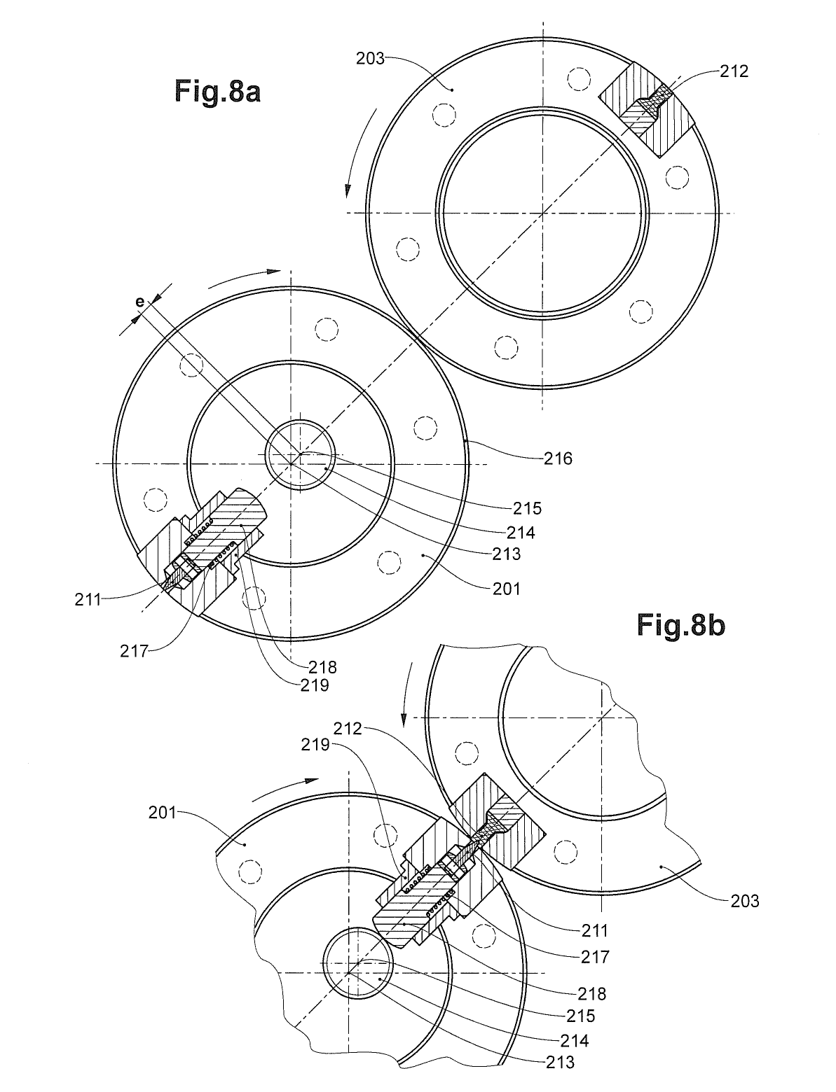

The travel mechanism for the scoring knife 211 is represented more accurately in FIG. 8a+b and 9a+b. FIG. 8a+b shows the rollers 201, 203 in the scoring position (FIG. 8b) cooperating with one another for scoring, as well as in a position rotated by 180° (FIG. 8a). FIG. 9a+b shows sections through the scoring roller 201 for representing the travel mechanism. Thereby, FIG. 9b shows a section along the line A-A in FIG. 9a.

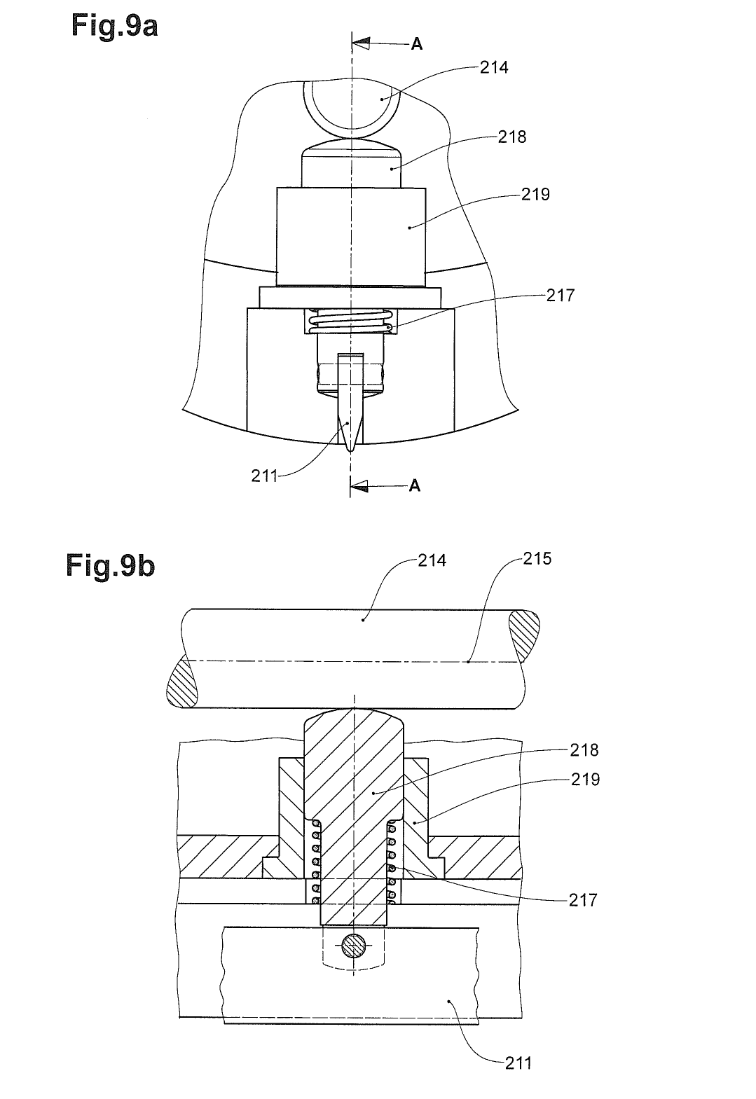

The roller 201 is designed as a hollow cylinder. The scoring knife 211 is connected to pins 218 which are arranged in sleeves 219, in the wall of the hollow cylinder (FIG. 10b). The scoring knife 211 is accessible from the outside by way of a recess in the wall. A spring 217 biases the pin 218 to the axis 213 of the roller 201. If no force is exerted on the pin 218, the scoring knife 211 is located in a position, in which its outwardly pointing scoring edge is retracted behind the lateral surface 216. The knife 211 can be lifted above the lateral surface 216 against the pressure of the spring by way of pressure on the pin 218. A control cam 214 in the form of a cylindrical rod or tube is present for this. The control cam 214 is arranged within the hollow region of the roller 201 in a manner such that its axis 215 runs parallel but at a distance e to the axis 213 of the roller 201. The free end of the pin 218, during the rotation of the roller, slides at least in regions on the control cam 214 and is lifted or lowered by way of this. The lift of the scoring knife 211 can be set by way of adapting the eccentricity e between the roller 201 and the control cam 214.

FIG. 10a+b show the setting mechanism 200 for setting the eccentricity e between the roller 201 and the control cam 214, wherein FIG. 10b shows a section along the line B-B in FIG. 10a. The two rollers 201, 203 with the scoring knife 211 and counter tool 212 are rotatably mounted about their axes 213 and 203′ respectively, in a housing of the folding assembly 200. The position of the axes 213, 203′ is stationary. The control cam 214 is mounted on a bearing journal 223 by way of which the axis 215 of the control cam 214 is fixed. The bearing journal 223 is displaceable in the direction of the line B-B in FIG. 10a. For this, the bearing journal 223 is pressed by way of a spring 221 in the direction of the connection plane between the axes 215, 203′ (line B-B) and exerts a counter-pressure by way of a setting screw 222. The position of the bearing journal 223 can be set and fixed with the setting screw 222.

FIG. 10b also shows that the scoring knife 211 is mounted via several pins 218 and sleeves 219 in the wall of the roller 210. In this manner, one prevents the scoring knife 211 deforming in a non-uniform manner on operation.

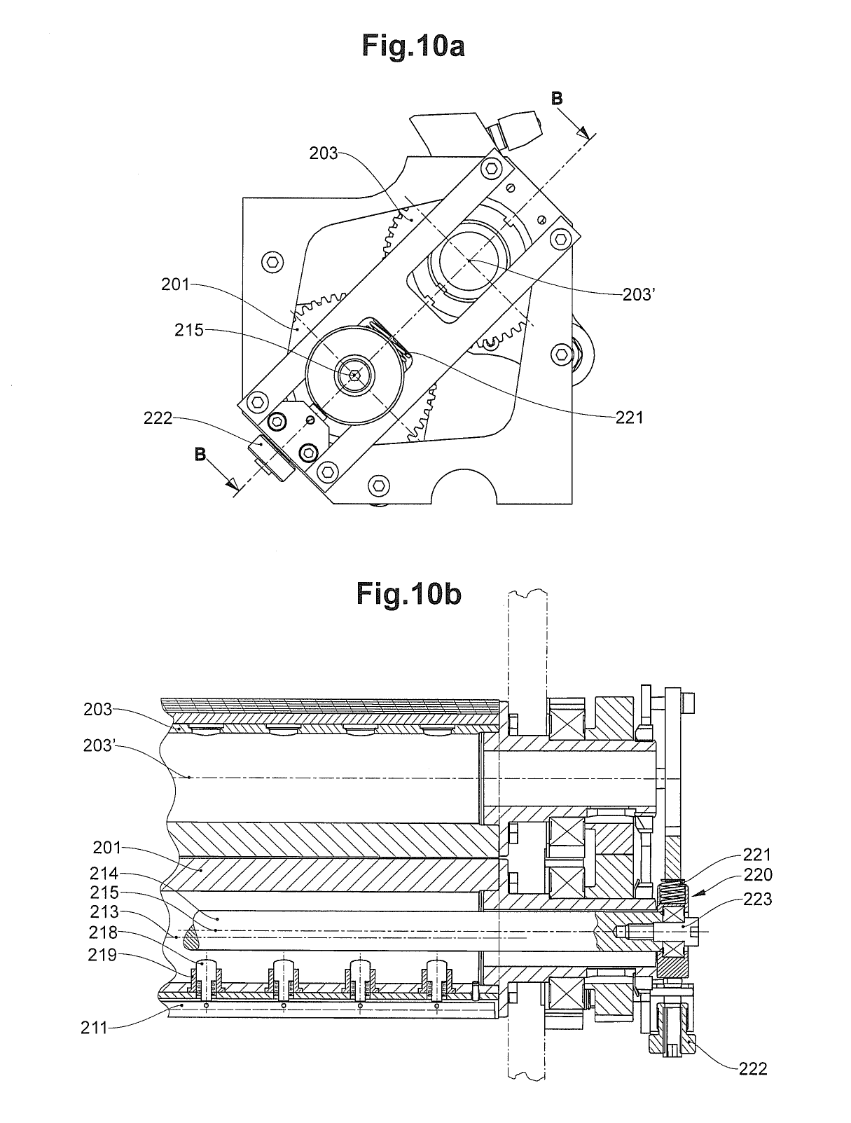

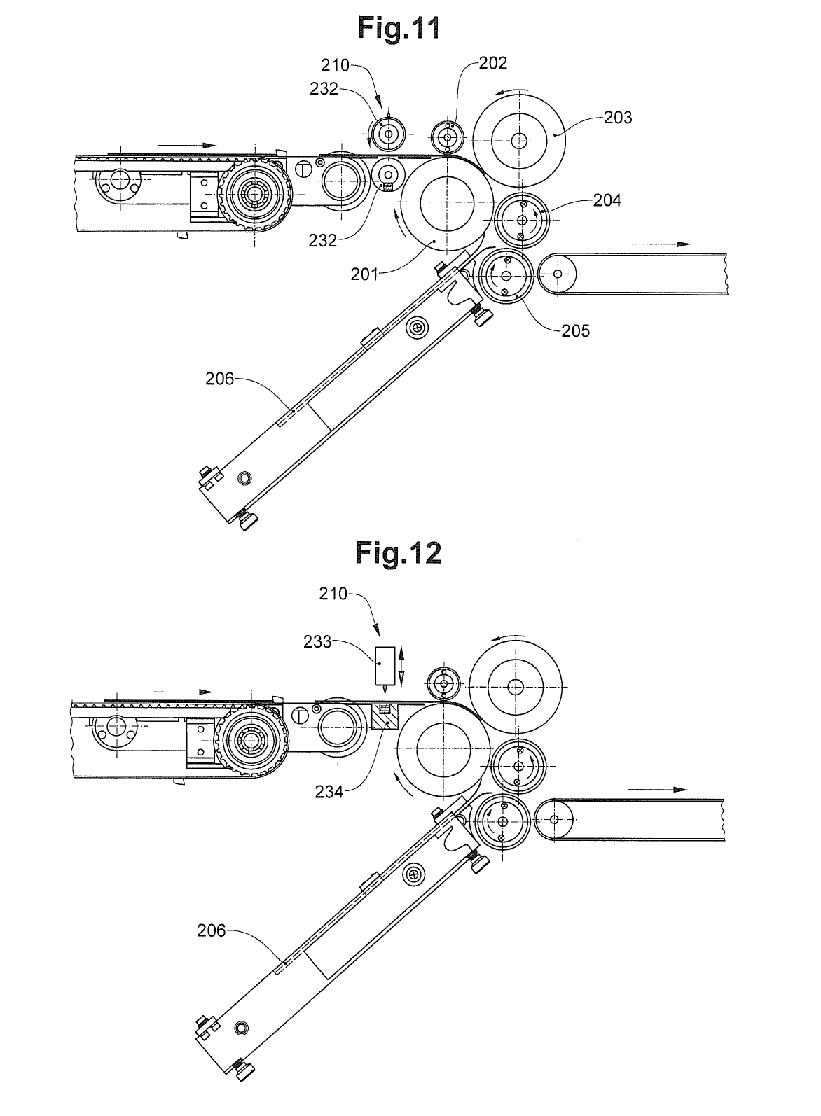

FIGS. 11 and 12 show variants of the device described above, with which the scoring device 210 in each case is arranged upstream of the actual folding assembly 200.

With FIG. 11, two rollers 231, 232 which cooperate with one another and of which one carries a scoring knife and the other a counter-tool, are arranged in front of the entry of the buckle folding assembly 200. The sheet runs through between the rollers 231, 232 and is scored when the scoring knife is located in the scoring position (here at “6 o'clock”). The drive of the scoring device 210 is synchronised with the advance of the sheet, so that the scoring is effected at the predefined position. The scoring knife does not need to be sinkable since the scoring roller 231 does not come into contact with the other rollers, as is the case with the counter-roller 232.

FIG. 12 shows a further device, with which the scoring device 210 comprises a scoring tool 233 moved up and down, and a stationary counter-element 234.

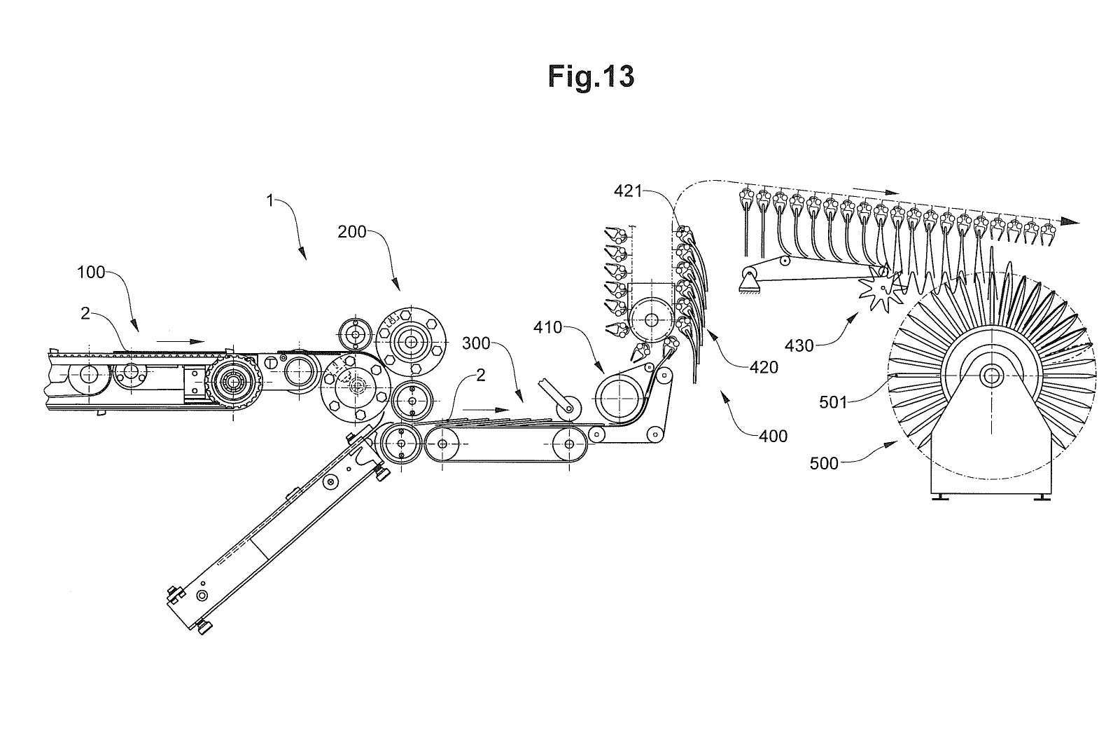

The device 1 according to the invention is shown in FIG. 13-15 in the context of a processing installation. Different variants of the further processing of the folded sheets are represented, e.g. by way of collecting, collating and inserting. The processing of the sheets from the unfolded condition up to the further processing is effected in a stream. The device 1 according to the invention is used as a feeder for devices for further processing which are known per se.

In FIG. 13, folded sheets 2 which come from the processing device 1 are deposited in imbricate formation on the conveyor belt of the conveying-away device 300. An intermediate conveyor 400, by way of which the sheets are transferred to a collection drum 500, is located downstream of the conveying-away device 300. The intermediate conveyor 400 comprises a singularisation device 410, in which the sheets 2 are singularised. The sheets 2 at the exit of the singularisation device 410 with the fold edge in front are transferred to grippers 421 of a gripper conveyor 420. The gripper conveyor 420 conveys the sheets up to the collection drum 500. Before the transfer to the collection drum 500, the folded sheets 2 are opened by an opening device 420, by way of an opening worm being applied. The sheets are then applied onto saddles 501 of the collection drum 500 and are transferred to the collection drum 500 by way of opening the grippers 421. Before and/or later, further products can be transferred to the collection drum 500. The collected products can be subsequently stitched and cut.

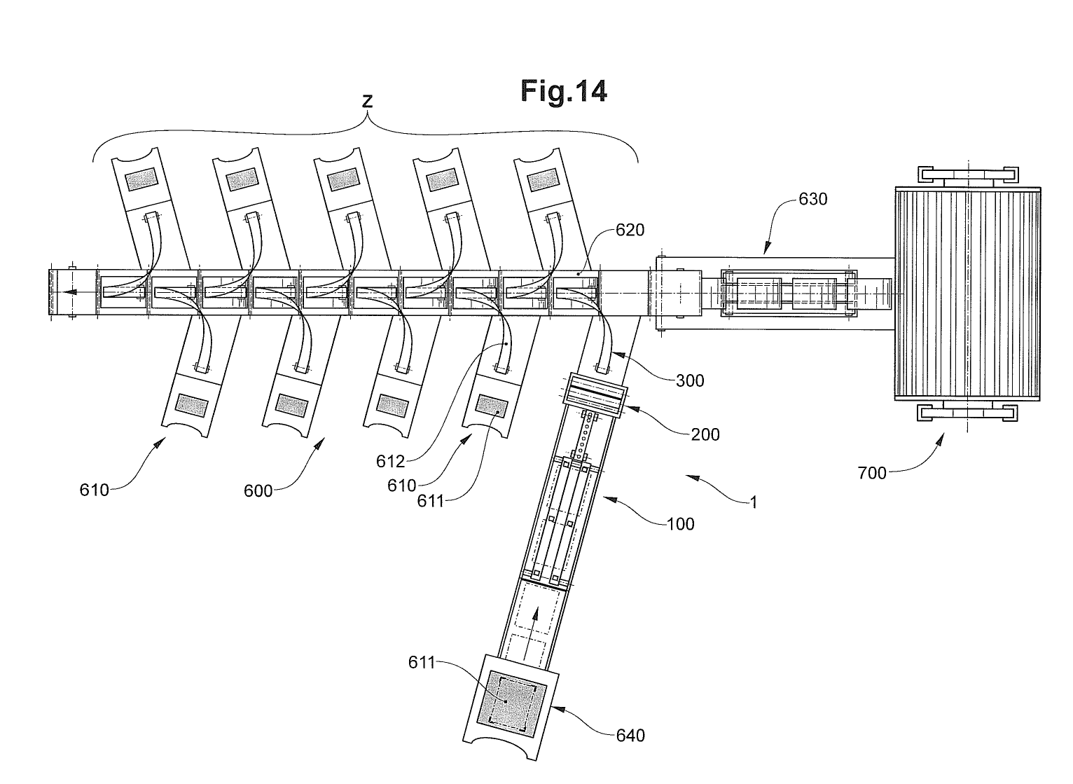

The device 1 according to the invention is applied as a feeder for a collation device 600 in FIG. 14. The collection device, for example, is designed as is described in WO-A 2010/051651. It comprises several compartments 620 which are formed, for example, by grippers and which are moved along a closed revolving path. Several feeders 610 are arranged next to one another or amongst one another along a collation stretch Z, in a manner such that their exits lie next to one another. The feeders 610, for example, sever for withdrawing flat objects, e.g. printed products from a stack 611 and applying them onto rest surfaces of the compartments 620 of the collation device 600 via a feed device 612 designed in the manner of a looping. The feeders 610 are designed, for example, according to WO-A 2008/000099.

The device 1, according to the invention, here serves as a further feeder, by way of its conveying away device 300 likewise being designed a looping whose exit is arranged along the collation stretch Z. With the looping, the folded objects can be transported further in imbricate formation or individually and be dispensed to the compartments 620 individually. A feed module 640 for the sheets to be folded, which here, for example, are introduced as stacks 611, intermediately stored and subsequently singularised, is arranged upstream of the feed device 100.

The collated objects run through the collation stretch in the arrow direction (to the left) and at the lower side of the collation device 600 (not visible here) are moved opposite to the arrow direction to the transfer region 630. Thereby, they are held in the compartments 620. The stacks are released from the compartments in the transfer region 630 and applied onto a conveyor belt. From there they are introduced into the compartments of an insert drum 700. This, for example, is designed as described in WO-A 2009/143645.

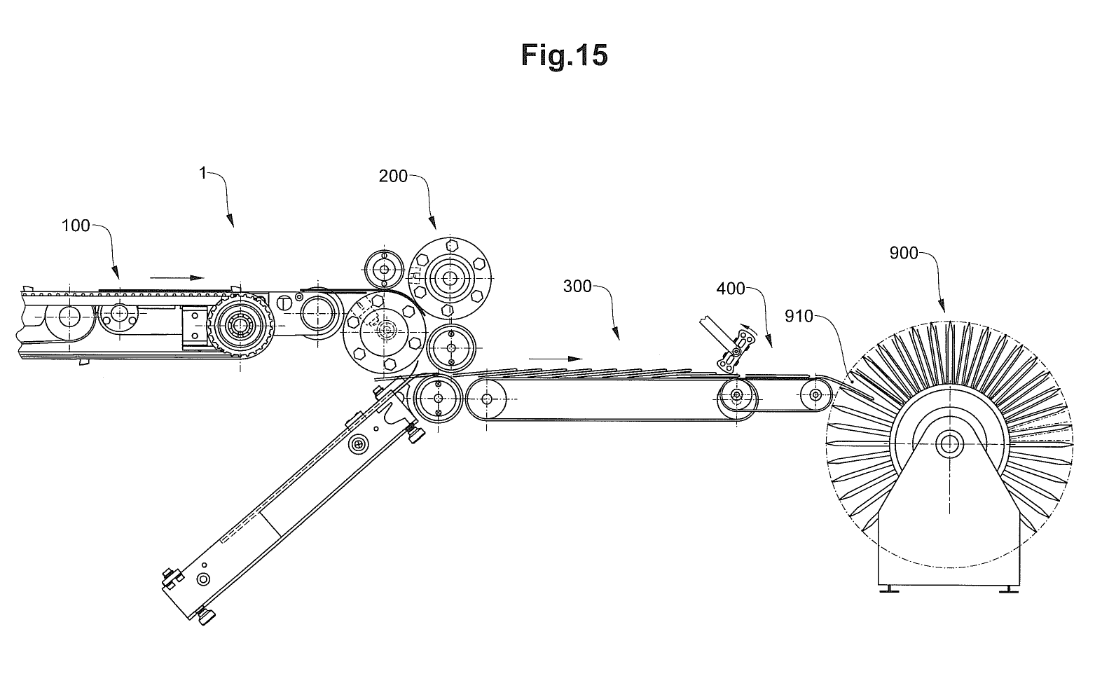

FIG. 15 shows a further example, with which the device according to the invention is used as a feeder for an insert drum 900. The folded sheets are transported in imbricate formation through the conveying-away device 300. At the exit of the conveying-away device 300, they are singularised and are introduced by way of an intermediate conveyor 400, here a belt conveyor, into compartments 910 of the insert drum 900. There, they can be opened, and further products can be inserted into the opened sheets.

1. A device for processing sheets of paper or of another flat, flexible material, in particular printed products, the device comprising:
a feed device for conveying sheets in a conveying direction (F) at a distance (d) of their leading edges to one another;
a folding assembly which is arranged downstream of the feed device;
wherein the folding assembly is a buckle folding assembly for creating at least one fold on the sheet, said fold being orientated transversely to the conveying direction;
further comprising a scoring device which is capable of scoring the sheets before the folding and during the conveying, at the location of the envisaged fold transversely to the conveying direction (F).

2. A processing device according to claim 1, wherein the buckle folding assembly comprises at least three rollers as well as a folding plate with an adjustable abutment, wherein at least in each case two of the rollers cooperate with one another as folding rollers or feed rollers.

3. A processing device according to claim 2, wherein the scoring device is integrated into at least one of the rollers of the buckle folding assembly.

4. A processing device according to claim 3, wherein the scoring device comprises an elongate scoring knife which is arranged essentially parallel to the axis of the assigned roller in the region of the lateral surface of the roller.

5. A processing device according to claim 4, wherein the scoring knife is movably arranged relative to the lateral surface, wherein the scoring knife projects out of the lateral surface or is lowered into or behind the lateral surface, depending on the rotation position of the roller.

6. A processing device according to claim 4, wherein the scoring device comprises an elongate counter-element, which is arranged on a roller cooperating with that roller which carries the scoring knife.

7. A processing device according to claim 5, wherein the travel of the scoring knife is settable by way of an adjustable control cam.

8. A processing device according to claim 1, wherein the feed device comprises an aligning device with at least one movable abutment, on which the sheets are aligned at a distance (d) of their leading edges.

9. A processing device according to claim 1:
wherein the feed device has an aligning device with at least one movable abutment, on which the sheets are aligned at a distance (d) of their leading edges;
wherein the scoring device comprises at least two rollers which are driven in opposite directions and whose axes are orientated perpendicular to the conveying direction (F) and of which one carries an elongate scoring knife orientated parallel to the axes; and
wherein the circumference of the rollers corresponds to the distance (d), in which the sheets are aligned.

10. A processing device according to claim 8, wherein the aligning device and the scoring device are driven synchronously to one another.

11. A processing device according to claim 8, wherein the aligning device is capable of creating a defined distance of the front edges of the sheets or a defined pace, in which the sheets are transferred to the folding assembly.

12. A processing device according to claim 8, wherein a phase shift between the at least one abutment of the aligning device and the scoring device can be set for adaptation to different distances of the scoring to the leading edge of the sheet.

13. A processing device according to claim 8, wherein the aligning device contains at least one abutment which defines an abutment surface (P) which acts on a sheet edge and whose orientation relative to the conveying direction can be set.

14. A processing device according to claim 13, wherein the abutment comprises at least two abutment elements which cooperate with one another and which together define the abutment surface (P) and whose position relative to one another is settable.

15. A processing device according to claim 14, wherein the aligning device comprises two parallel strips which in each case carry abutment elements at equal distances (d) and which are driven via different drive shafts.

16. A processing device according to claim 15, wherein the rotation position of the drive shafts relative to one another can be set, in order to set the position in each case of two cooperating abutment elements.

17. A processing device according to claim 8, further comprising a transfer conveyor, with which the aligned sheets can be transferred from the aligning device to the folding assembly without a change of their orientation relative to the conveying direction (F), wherein the transfer conveyor is a vacuum conveyor, on whose conveyor belt the sheets are fixed by way of a vacuum.

18. A processing device according to claim 1, further comprising a conveying-away device which is arranged downstream of the folding assembly, wherein the conveying-away device comprises a belt conveyor.

19. A method for processing sheets of paper or another flat, flexible material, in particular printed products, comprising the following steps:
conveying the sheets in a conveying direction (F) at a distance to one another or in an imbricate formation;
feeding the sheets to a folding assembly which is a buckle folding assembly;
creating at least one fold which runs transversely to the conveying direction (F);
wherein before the folding, the sheet is scored at the location of the envisaged fold transversely to the conveying direction (F) with a scoring device whilst the sheet is conveyed.

20. A method according to claim 19, wherein the sheet is scored in the entry region of the folding assembly, by way of a scoring knife being integrated into one of the rollers of the folding assembly.

21. A method according to claim 20, wherein the scoring knife periodically revolves about an axis of the roller.

22. A method according to claim 19, wherein the sheets are fed in a paced manner, wherein the distances (d) of the front edges of the sheets are constant and correspond to the diameter of the roller, into which the scoring knife is integrated.

23. A method according to claim 21, wherein the scoring knife is moved such that it projects out of the lateral surface of the roller or is sunk into or behind the lateral surface, at the pace of the feeding of the sheets.

24. A method according to claim 19, wherein the sheets, before entry into the scoring device, are aligned by way of an aligning device in a manner such that their leading edges are orientated perpendicularly to the conveying direction (F).

25. A method according to claim 23, wherein the orientation of an abutment surface (P) of the aligning device, on which the leading edges are aligned, is set during operation.

26. A method according to claim 19, wherein an end product or intermediate product is created by way of the folded sheets being led together with further flat printed products, by way of at least one of the following processes:
collating
inserting
collecting.

27. The use of a device according to claim 1, as a feeder for a collation device, an insertion device or a collection device.
